(19) United States
(12) Patent Application Publication
(10) Pub. No.: US 2008/0145581 A1
(43) Pub. Date: Jun. 19, 2008

(54) Peelable multilayer laminate for packaging

(76) Inventor: Stephen Robert Tanny, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/638,920

(22) Filed: Dec. 14, 2006

(51) Int. Cl. B32B 27/08; B32B 33/00

(52) U.S. Cl. 428/36.6; 428/40.9

(57) ABSTRACT

Multilayer laminate compositions are provided wherein at least one layer of the laminate comprises a blend of a) an organic acid and ethylene/acid copolymer or ethylene/acid that are at least partially neutralized with a metal ion and b) an ethylene homopolymer or copolymer of ethylene and an alpha-olefin form at least one layer of a multilayer laminate. At least one other layer of the laminate is a gas impermeable composition consisting essentially of a material selected from the group consisting of polyvinylidene chloride, ethylene vinyl alcohol polymers, polyamides, metal foils, metallized films or liquid crystalline polyesters and mixtures thereof. The gas permeable layer is easily peelable and may be separated manually from the gas impermeable layer of the laminate. The laminates are useful in packaging applications, including manufacture of lid stock.

### FIELD OF THE INVENTION

This invention relates to a multilayer laminate having gas-permeable and gas-impermeable layers. In addition, the invention relates to packaging structures for products that comprise the multilayer laminate.

### BACKGROUND OF THE INVENTION

Strippable barrier films are useful for packaging in which a barrier layer is needed to preserve or extend the shelf life of a product for a period of time after which it is desirable to expose the product to oxygen. For example, European Patents 1358068 and 1035970 disclose packaging that incorporates an oxygen barrier film which may be easily peeled from a gas impermeable barrier layer of the laminate, thus allowing air to enter the package to effect a desired change in the packaged product.

Red meat presents particular challenges with respect to shelf life and aesthetics. Specifically, while a low-oxygen environment generally increases the shelf life of packaged meat, red meat has a tendency to assume a purple color when maintained under such conditions. This color is undesirable to most consumers. When meat is exposed to a sufficiently high concentration of oxygen, e.g., as found in air, it assumes a bright red color which most consumers associate with freshness. It would be desirable that red meat be packaged, shipped and stored in a low oxygen environment for extended shelf life, then displayed in a high oxygen environment so that the meat “blooms” and becomes an attractive red color just before being placed in the retail display case.

While strippable barrier films are known in the art, ease of stripping or delaminating the barrier layer has, for the most part, required specific formulation of layers in the structure that provides the ability to delaminate. For example, U.S. Pat. No. 5,779,050 discloses heat sealing multilayer film to a container. With packages of this type difficulty is often encountered when delaminating the impermeable layer from the gas permeable layer. In particular, the impermeable layer is often not completely removed. Additionally, if the impermeable layer fails to properly delaminate from the gas permeable layer, it is possible to damage the seal. Specific layers are often formulated to incorporate expensive components such as polybutene or Elvaloy® acrylate polymers. Even so, these formulations often do not provide the ease of delamination required by the user.

A further challenge in packaging red meat is the desirability of rapid “blooming” after removal of the gas impermeable barrier film. One solution to this problem provided by the prior art the use of perforated gas permeable films. For example, gas permeable films disclosed in U.S. Pat. Nos. 5,667,827 and 5,711,978 have very small perforations that function to increase the rate of bloom. A disadvantage of such films is that the perforations provide potential for leakage of juices from the meat. In addition, conventional pressure and heat mechanisms used to bond the gas permeable and gas impermeable layers can close the perforations. Further, the use of adhesives can often occlude the perforations.

Thus, it would be desirable to have a multilayer laminate that provides ease of delamination of a barrier layer from conventional, low cost materials commonly used in packaging films, such as ethylene vinyl acetate or polyethylene, while also exhibiting a rapid rate of “bloom” after removal of the gas impermeable barrier film.

### SUMMARY OF THE INVENTION

In one aspect the present invention is directed to a multilayer laminate comprising:
A. a gas permeable layer comprising a blend of
   1. a polar copolymer composition comprising at least one ethylene copolymer selected from the group consisting of a) ethylene acid copolymers having copolymerized units of ethylene, at least one C₃ to C₈ α,β-ethylenically unsaturated carboxylic acid and optionally a comonomer selected from the group consisting of alkyl acrylates and alkyl methacrylates, wherein said alkyl groups have from 1 to 8 carbon atoms, b) metal salts of said ethylene acid copolymers and c) mixtures thereof;
   2. a polar organic compound composition comprising at least one organic compound selected from the group consisting of a) aliphatic organic acids having fewer than 36 carbon atoms and b) alkaline earth metal salts thereof,
wherein greater than 70% of the combined total acid moieties of said polar copolymer composition and said polar organic compound composition have been neutralized to the corresponding metal salts, and
   3. at least one additional polymer selected from the group consisting of a) ethylene homopolymers and b) ethylene copolymers other than an ethylene acid copolymer or a metal salt of an ethylene acid copolymer and
B. a gas impermeable layer consisting essentially of a material selected from the group consisting of polyvinylidene chloride, ethylene vinyl alcohol polymers, polyamides, metal foils, metallized films, liquid crystalline polyesters and mixtures thereof,
wherein the gas permeable layer may be easily peeled from the gas impermeable layer.

The invention is further directed to a lidstock film comprising the above-described multilayer laminate, additionally comprising an adhesive layer positioned on an exterior surface of the laminate.

### DETAILED DESCRIPTION OF THE INVENTION

In one aspect the present invention is directed to a multilayer structure, i.e. a multilayer laminate, comprising a gas permeable layer, A and a gas impermeable barrier layer, B. The term “gas permeable” as used herein denotes a film or film portion which admits at least about 1,000 cc of gas, such as oxygen, per square meter of film per 24 hour period at 1 atmosphere and at a temperature of 73° F. (at 0% relative humidity). Such laminates are particularly suited for packaging red meats, for example beef, pork, veal and lamb. The gas impermeable layer, B of the laminate may be one or more layers consisting essentially of a material selected from the group consisting of polyvinylidene chloride, ethylene vinyl alcohol polymers, polyamides, metal foils, metallized films and liquid crystalline polyesters.

The gas permeable layer, A of the laminate is a blend of a polar copolymer composition, A1, and a polar organic compound composition, A2, and at least one additional ethylene homopolymer or ethylene copolymer, A3, wherein the ethylene copolymer is other than the polar copolymers of A1.

The polar copolymer composition, A1, of the gas permeable layer comprises one or more species selected from the group consisting of ethylene acid copolymers, metal salts, i.e. ionomers, of the copolymers and mixtures thereof. More specifically, suitable ethylene acid copolymers or their metal salts which comprise the polymer copolymer composition, i.e. component A1, are ethylene acid copolymers having copolymerized units of ethylene, at least one C₃-C₈ α,β-ethylenically unsaturated carboxylic acid and optionally a comonomer selected from the group consisting of alkyl acrylates and alkyl methacrylates, wherein said alkyl groups have from 1 to 8 carbon atoms.

The polar organic compound composition, A2, comprises one or more species selected from the group consisting of aliphatic organic acids, metal salts of the acids and mixtures thereof. More specifically, compounds suitable for use in the polar organic compound composition of the gas permeable layer, i.e. component A2, are aliphatic, mono-functional organic carboxylic acids or their metal salts, particularly those having fewer than 36 carbon atoms. The acids may be saturated or unsaturated, and may include multiple sites of unsaturation.

Particularly useful organic acids include acids having from four to 34 carbon atoms. More preferred are acids having six to twenty-six carbon atoms, and even more preferred are acids having six to twenty-two carbon atoms. Organic acids useful in the practice of the present invention include but are not limited to caproic acid, caprylic acid, capric acid, palmitic acid, lauric acid, stearic acid, isostearic acid, behenic acid, erucic acid, oleic acid, and linoleic acid and their mixtures. More preferably, the naturally derived organic fatty acids such as palmitic, stearic, oleic, behenic, and mixtures thereof can be conveniently employed. Saturated organic acids may be preferred for the purpose of reducing organoleptic properties of structures made from the compositions of the invention. Such structures can include films and other packaging materials. Stearic acid may be preferred in certain laminate applications.

Saturated, branched organic acids may be particularly preferred to provide greater oxygen permeability. Of the branched saturated acids, isostearic acid is particularly preferred. One of ordinary skill will appreciate that mixtures of any of the organic acids contemplated herein can provide properties that can be expected or anticipated from the properties of the individual organic acid components.

The metal salts of polar copolymer composition A1 and polar organic compound composition A2 are selected from alkaline metal salts, alkaline earth metal salts or zinc salts.

It is preferred that the A1 and A2 components useful in the gas permeable layer of the laminates of the invention are present in a particular ratio. That is, preferably the total component A2 compositions, i.e. the total A2 acids or salts thereof or mixtures thereof, are present in an amount of from about 3 to about 55 wt. %, preferably, from about 5 to about 25 wt. %, based on the total combined weight of components A1 and A2, where A1 is the total amount of ethylene acid copolymers, ionomers or mixtures thereof that are present in the composition.

An important aspect of the present invention is that the combined total carboxylic acid groups, i.e. carboxylic acid moieties, of the polar organic compound component A2 and the polar ethylene acid component A1 that are present in the gas permeable layer are neutralized to the corresponding alkali-metal salts, alkaline earth metal salts, or zinc salts, particularly the magnesium and calcium salts, in an amount greater than 70%. High levels of neutralization, above 70%, can be obtained by adding a stoichiometric amount of a cation source calculated to neutralize the target amount of total carboxylic acid moieties in the acid copolymer and organic acid(s) in the blend (hereinafter referred to as “% nominal neutralization” or “nominally neutralized”). Thus, for example, sufficient calcium or magnesium cations or mixtures thereof are made available in the blend so that, in aggregate, the indicated level of nominal neutralization is achieved. Preferably the % nominal neutralization will be greater than about 80%, more preferably greater than about 90%, and even more preferably from about 91% to about 100%.

The additional polymer, i.e. component A3, is a polymer selected from the group consisting of a) ethylene homopolymers and b) ethylene copolymers other than the ethylene acid copolymers and metal salts thereof that are present as component A2 compositions. Suitable ethylene copolymers include copolymers of ethylene and an alpha-olefin having three or more carbon atoms. Specific examples of suitable polymers include branched polyethylenes, such as low density polyethylenes, linear low density polyethylenes, ultra low density polyethylenes, very low density polyethylenes, metallocene polyethylenes, ethylene propylene copolymers and copolymers of ethylene, propylene and a diene monomer. These latter copolymers are commonly referred to in the art as EPDM copolymers. EPDMs include terpolymers as well as higher order copolymers such as tetrapolymers. Tetrapolymers include, for example, copolymers of ethylene, propylene, 1,4-hexadiene and ethylidene norbornene. The term metallocene polyethylene as used herein is meant to include those polyethylenes that are prepared in the presence of metallocene catalysts as well those prepared in the presence of constrained geometry catalysts and single site catalysts. Other suitable ethylene copolymers include those that have copolymerized units of polar monomers such as alkyl acrylates, alkyl methacrylates, unsaturated esters, carbon monoxide, and unsaturated anhydrides.

Optionally, other polymers different from those of the A1 and A3 components may be present in the composition. These may include polyamides, polyesters and other thermoplastic or elastomeric polymers. Particularly useful combinations of A3 component polymers include blends of polyethylene homopolymers and ethylene alpha-olefin polymers with ethylene unsaturated ester copolymers having copolymerized units of ethylene and a comonomer selected from the group consisting of vinyl acetate, alkyl acrylates and alkyl methacrylates. Blends of these particular polymers provide compositions particularly suited for packaging meat, fish, sausage, fresh produce, and the like.

The present invention provides an improvement in the oxygen permeability value, OPV, of previously described films obtained from ethylene acid copolymer/organic acid blends. It has been discovered that there can be an improved effect when an ethylene homopolymer or ethylene-containing copolymer that is neither an ethylene acid copolymer nor an ionomer is blended with a neutralized acid copolymer/organic acid blend, particularly with respect to the OPV. It has been found that inclusion of the ethylene-containing copolymer can improve OPV even though the level of ethylene acid copolymers is reduced. That is, a blend comprising a neutralized copolymer of ethylene and an α,β-ethylenically unsaturated carboxylic acid/organic acid blend with an ethylene-containing copolymer can provide OTR of greater than 10,000 cc/m²/24 hr. In addition to improving the OTR of films of the present invention, the ethylene copolymer blends of the present invention provide good moisture barrier properties, and show improved processibility relative to similar blends wherein the ethylene homopolymer or ethylene-containing copolymer is absent.

In addition to the polymeric components of the gas permeable and gas impermeable layers, various other additives, commonly used in packaging applications may be present in the compositions. These include antioxidant additives that can be useful in modifying the organoleptic properties (i.e. reducing odor or taste) of the blends of this invention. The use of antioxidants may be preferred when an organic acid present in component A2 is unsaturated. Suitable antioxidants are available under the trade name Irganox® from Ciba Geigy Inc. Tarrytown, N.Y. For example, phenolic antioxidants such as Irganox® E201 antioxidant or its derivatives may be added to the blend. Irganox® 1010 antioxidant is also suitable for use in this invention. Additional common additives include antiblocking agents, such as silica, tackifiers, for example, Regalite® tackifier, available from Eastman Chemical Corp. and Escorez® resin, available from ExxonMobil Corp., and slip additives, such as erucamide or stearamide.

The gas impermeable layer of the laminate consists essentially of a material selected from the group consisting of polyvinylidene chloride, ethylene vinyl alcohol polymers, polyamides, metal foils, metallized films, liquid crystalline polyesters and mixtures thereof. By consists essentially of is meant that the specified materials are present and other components that do not materially affect the basic and novel characteristics of the gas impermeable layer may also be present. Thus, additional polymeric components and other additives may be present.

The multilayer laminate structure comprises at least two layers, a gas permeable layer and a gas impermeable layer as described above. Other optional layers may be included in the laminated structure to provide additional features such as rigidity and toughness. For example, the multilayer laminate may contain one or more optional adhesive tie layers. The additional layers may be disposed between the gas impermeable layer and the gas permeable layer in a multilayer structure. In other embodiments the gas impermeable and gas permeable layers will contact each other in the relationship of adjacent layers. The thickness of the laminate layers depends on the properties desired. As the thickness of the gas permeable layer increases, permeability decreases. The thickness of the gas permeable layer is inversely proportional to the gas transmission rate.

The laminates of the invention provide structures that are easily peelable. That is, the gas permeable layer will peel easily from the other layers of the laminate. That is, the gas permeable layer may be removed manually from the other layers of the laminate. Thus, the laminates of the invention have relatively low bond strength, generally below 5 lb. per inch of seal width. The force required to separate the gas permeable layer from the other layers of the laminate that include or constitute the gas impermeable layer is controlled by the bond strength between the gas permeable layer and the layer adjacent to it. Bond strength in a peelable system is controlled by the composition of either or both of the layers that are in intimate contact at the interface at which separation is to occur. Typical consumer goods packages have a seal strength of 1-3 lb per in. of seal width, as measured via a standard test such as ASTM F88-94.

In some embodiments of the invention, the gas permeable layer will contact the gas impermeable layer as an adjacent layer. In such constructions, the two layers may be easily peeled from each other. In other embodiments, wherein additional layers are disposed between the gas permeable layer and the gas impermable layer, easy peelability will be achieved in other ways. For example, the gas permeable layer may contact another layer that is disposed between the gas permeable layer and the gas impermeable layer, which layer is easily peelable from the gas permeable layer. In such instances, manual separation will result in separation of the gas permeable layer from the remaining layers of the laminate. Conversely, the gas impermeable layer may contact another layer that is disposed between the gas permeable layer and the gas impermeable layer, which layer is easily peelable from the gas impermeable layer. In such instances, manual separation of the gas impermeable layer from the remaining layers of the laminate will occur. In addition, several layers may intervene between the gas permeable and gas impermeable layers. These layers may be easily peelable from one another. In such instances, manual separation of the layers will result in formation of a gas permeable layer that remains laminated to a layer other than the gas impermeable layer. However, the gas impermeable layer will be removed from the laminate during the separation process.

The layers of the laminates of the present invention have bond strengths low enough to permit the layers to be separated manually thus allowing removal of the gas impermeable layer from the gas permeable layer or the multilayer laminate structure of which the gas permeable layer is a part.

Laminate layers that consist essentially of gas impermeable compositions such as ethylene vinyl alcohol, polyvinylidene chloride, polyvinyl chloride, metallized films, polyesters, and polyamides will peel easily from a layer of the gas permeable composition.

Preferred examples of compositions that may be used in layers adjacent to the gas permeable layer and which will provide easy peelability include polyethylene, copolymers of ethylene and alpha-olefins having a density greater than 0.90 g/cc; polypropylene, copolymers of propylene and alpha olefins wherein the polymer has a melting point greater than of about 140° C.; copolymers of ethylene and polar monomers where the polar monomers are selected from the group consisting of vinyl acetate, alkyl acrylates, alkyl methacrylates, maleic anhydride and combinations thereof wherein the total amount of comonomer is less than 20% by weight.

In another aspect of the present invention a lidstock film capable of bonding to a rigid tray or cup is provided. The lidstock film comprises the above-described multilayer laminate additionally comprising an adhesive layer. The adhesive layer adheres the gas permeable layer of the multilayer laminate to the rigid container. Suitable adhesives depend on the material used for the rigid container and on the gas permeability desired of the lidstock multilayer film. Adhesive layers may be selected from but not limited to polyolefins and modified polyolefins. More preferred are ethylene vinyl acetate copolymers and ethylene methyl acrylate copolymers.

### EXAMPLES

### Example 1

A film is produced on a three layer blown film line. The outer or first layer, consists of an ethylene vinyl acetate copolymer having a melt index of 3.0 g/10 minutes (190° C., 2.16 kg weight) and a vinyl acetate content by weight of 28%, blended with an ethylene vinyl acetate slip and antiblock masterbatch in the ratio of 95% to 5% wt. %. The second or core layer is a copolymer of ethylene and octene prepared in the presence of a metallocene (single site) catalyst, the copolymer having a density of approximately 0.87 g/cc, a melt index of 1.0 g/10 minutes (190° C., 2.16 kg weight) and a DCS peak melting point of approximately 55°-60° C. The third, gas permeable, layer is a blend of 55 parts of a terpolymer composed of copolymerized units of ethylene, isobutyl acrylate and methacrylic acid (wt. ratio of monomers 55/10/10), 20 parts magnesium stearate and 25 parts of a dipolymer of ethylene and methyl acrylate (24 wt. % methyl acrylate), the acid groups of the blend components being neutralized with magnesium hydroxide to a nominal degree of 100%. The thickness of the three-layer blown film is approximately 2.5 mils.

A second film consisting of 5 layers is also produced on a blown film line. This film is constructed with an inner layer consisting of a copolymer of ethylene vinyl acetate containing 12 wt % vinyl acetate and having a melt index of 2.5 g/10 minutes (190° C., 2.16 kg. weight). This film has a first tie layer positioned between the inner layer and a gas impermeable barrier layer. This first tie layer is an anhydride modified linear low density polyethylene polymer having a density of 0.91 g/cc and a melt index of 1.7 g/10 minutes (190° C., 2.1 kg wt.) The barrier layer is a copolymer of ethylene and vinyl alcohol having 38 mole % copolymerized ethylene units. The film has a second tie layer between the barrier layer and an outer layer. The second tie layer is formed of the same composition as the first tie layer. The outer layer consists of a blend of high density polyethylene with a density of 0.960 g/cc and a melt index of 1.0 g/10 minutes (190° C., 2.16 kg weight) and high pressure low density polyethylene with a density of 0.923 and a melt index of 1.0 g/10 minutes (190° C., 2.16 kg weight). The second film has average total thickness of 4.0 mils. The barrier layer has an average thickness of 0.8 mils.

The first and second films are fed through a set of heat adjustable nip rollers under conditions such that a composite film is created wherein the inner layer of the first film is in contact with the inner layer of the second film and the films are blocked together.

A test sample 4 inches by 4 inches is cut from the composite film. The test sample is heat sealed under heat and pressure to cover the opening of a 3 inch diameter injection molded flanged cup made from a random copolymer of propylene and approximately 2 weight percent ethylene. The sealing operation is conducted so that the inner layer of the first film is in contact with the cup flange. The sealing operation leaves exposed edges of the composite film, creating a tab, so that the first film can be easily separated from the second film. The edge of the composite film is worked so as to separate the first film from the second film at the interface between the inner layers of each. The second film, containing the barrier layer is then peeled from the first film at a 90° peel angle. The sample peels cleanly and easily, leaving a membrane consisting of the first film attached to the cup without any visible delamination between the first film and the cup.

### Example 2

Using the procedure and materials described in Example 1 a laminate of the invention is prepared except that the gas permeable layer of the three-layer film is a blend of 55 parts of a dipolymer composed of copolymerized units of ethylene and methacrylic acid (wt. ratio of monomers 85/15), 20 parts of magnesium stearate and 25 parts of a dipolymer of ethylene and octene prepared using a metallocene catalyst (Engage® 8100 polyolefin resin, available from The Dow Chemical Co.), the acid groups of the blend components being neutralized with magnesium hydroxide to a nominal degree of 100%.

When test specimens made according to the procedure of Example 1 are prepared and tested the sample peels cleanly and easily.

### Example 3

Using the procedure and materials described in Example 1 a laminate of the invention is prepared except that the gas permeable layer of the three-layer film is a blend of 55 parts of a terpolymer composed of copolymerized units of ethylene, isobutyl acrylate and methacrylic acid (wt. ratio of monomers 80/10/10), 20 parts of magnesium stearate, 15 parts of a dipolymer of ethylene and methyl acrylate (wt. ratio of monomers 76/24) and 10 parts of a dipolymer of ethylene and octene prepared using a metallocene catalyst (Engage® 8100 polyolefin resin, available from The Dow Chemical Co.), the acid groups of the blend components being neutralized with magnesium hydroxide to a nominal degree of 100%.

When test specimens made according to the procedure of Example 1 are prepared and tested the sample peels cleanly and easily.

It is claimed:

1. A multilayer laminate comprising:
A. a gas permeable layer comprising a blend of
1. a polar copolymer composition comprising at least one ethylene copolymer selected from the group consisting of a) ethylene acid copolymers having copolymerized units of ethylene, at least one C₃ to C₈ α,β-ethylenically unsaturated carboxylic acid and optionally a comonomer selected from the group consisting of alkyl acrylates and alkyl methacrylates, wherein said alkyl groups have from 1 to 8 carbon atoms, b) metal salts of said ethylene acid copolymers and c) mixtures thereof;
2. a polar organic compound composition comprising at least one organic compound selected from the group consisting of a) aliphatic organic acids having fewer than 36 carbon atoms and b) alkaline earth metal salts thereof wherein greater than 70% of the combined total acid moieties of said polar copolymer composition and said polar organic compound composition have been neutralized to the corresponding metal salts and
3. at least one additional polymer selected from the group consisting of a) ethylene homopolymers and b) ethylene copolymers other than an ethylene acid copolymer or a metal salt of an ethylene acid copolymer and
B. a gas impermeable layer consisting essentially of a material selected from the group consisting of polyvinylidene chloride, ethylene vinyl alcohol polymers, polyamides, metal foils, metallized films, liquid crystalline polyesters and mixtures thereof
wherein the gas permeable layer may be easily peeled from the gas impermeable layer.

2. A multilayer laminate of claim 1 wherein the metal salts are alkaline earth metal salts.

3. A multilayer laminate of claim 1 additionally comprising at least one additional layer.

4. A multilayer laminate of claim 1 wherein an ethylene polymer of component A3 is selected from the group consisting of low density polyethylenes, linear low density polyethylenes, ultra low density polyethylenes, very low density polyethylenes, metallocene polyethylenes, ethylene propylene copolymers, copolymers of ethylene, propylene and a diene monomer, copolymers of ethylene and an alkyl acrylate, copolymers of ethylene and an alkyl methacrylate, copolymers of ethylene and an unsaturated ester, copolymers of ethylene and carbon monoxide and copolymers of ethylene and an unsaturated anhydride.

5. A multilayer laminate of claim 3 wherein at least one additional layer is an adhesive layer.

6. A multilayer laminate of claim 5 wherein the adhesive layer is in contact with the gas permeable layer of the laminate.

7. A multilayer laminate of claim 1 wherein the gas permeable layer comprises an additional polymer that is different from the polymers that comprise components A1 and A3 of the gas permeable layer.

8. A multilayer laminate of claim 1 wherein component A3 of the gas permeable layer consists essentially of a blend of a) at least one ethylenic polymer selected from the group consisting of polyethylene homopolymers and ethylene alpha-olefin copolymers and b) at least one ethylene copolymer selected from the group consisting of ethylene unsaturated ester copolymers having copolymerized units of ethylene and a comonomer selected from the group consisting of vinyl acetate, alkyl acrylates and alkyl methacrylates.

9. A multilayer laminate of claim 3 wherein at least one additional layer is disposed between the gas permeable layer and the gas impermeable layer.

10. A multilayer laminate of claim 9 wherein the layer that contacts the gas permeable layer and which is disposed between the gas permeable layer and the gas impermeable layer is easily peelable from the gas permeable layer.

11. A multilayer laminate of claim 9 wherein the layer that contacts the gas impermeable layer and which is disposed between the gas permeable layer and the gas impermeable layer is easily peelable from the gas impermeable layer.

12. A multilayer laminate of claim 9 wherein a layer which is disposed between the gas permeable layer and the gas impermeable layer is easily peelable from a layer with which it is in contact.

13. A lidstock comprising a multilayer laminate of claim 3.

14. A lidstock comprising a multilayer laminate of claim 12.

15. A shaped article comprising a rigid tray or cup having a lidstock comprising a multilayer laminate of claim 3.

16. A shaped article comprising a rigid tray or cup having a lidstock comprising a multilayer laminate of claim 12.

17. A package comprising a multilayer laminate of claim 1.

18. A package comprising a multilayer laminate of claim 3.

19. A package comprising a multilayer laminate of claim 12.
